(19) United States
(12) Patent Application Publication
(10) Pub. No.: US 2022/0220018 A1
(43) Pub. Date: Jul. 14, 2022

(54) FILTER MODULE FOR WATER DISPENSING DEVICE

(71) Applicant: LG ELECTRONICS INC., Seoul (KR)

(72) Inventors: Youngjae KIM, Seoul (KR); Changhwan Yoon, Seoul (KR); Gyeonghwan Kweon, Seoul (KR)

(21) Appl. No.: 17/573,796

(22) Filed: Jan. 12, 2022

(30) Foreign Application Priority Data
Jan. 13, 2021 (KR) 10-2021-0004519

(51) Int. Cl. C02F 9/00; C02F 1/28; C02F 1/44; B01D 63/02; B01D 39/16; B01D 39/18; B01D 61/14; B01D 61/18; B01D 61/20; B01D 35/30

(52) U.S. Cl. CPC C02F 9/005; C02F 2101/20; C02F 1/288; C02F 1/444; B01D 63/02; B01D 39/1623; B01D 39/18; B01D 39/1692; B01D 61/145; B01D 61/18; B01D 61/20; B01D 35/303; B01D 35/306; C02F 2307/12; B01D 2239/069; B01D 2239/0435; C02F 1/283

(57) ABSTRACT

A filter module for a water dispensing device according to the present disclosure includes a filter housing which has an inflow port and a discharge port, and a plurality of filters which includes a filtration member provided in the filter housing to purify water flowing therein through the inflow port and to supply purified water to the discharge port, and filtering raw water flowing therein from the outside into purified water, and the filter module includes a pre-filter through which raw water passes firstly and in which a first carbon block having a hollow shape is built-in, a hollow fiber membrane (UF membrane) filter through which water passes through the pre-filter passes secondly, an electrostatic adsorption member through which water passing through the hollow fiber membrane filter passes thirdly, and a second carbon block through which water passing through the electrostatic adsorption member passes fourthly.

### CROSS-REFERENCE TO RELATED APPLICATION

The present application claims priority under 35 U.S.C. 119 and 35 U.S.C. 365 to Korean Patent Application No. 10-2021-0004519, filed in Korea on Jan. 13, 2021, which is hereby incorporated by reference in its entirety.

### BACKGROUND

### 1. Field

The present specification relates to a filter module for a water dispensing device having an electrostatic adsorption function.

### 2. Background

In general, water dispensing devices such as water purifiers and refrigerators refer to devices for purifying raw water such as tap water or groundwater. In other words, the water dispensing device refers to a device for converting raw water into drinking water through various purification methods and providing the drinking water. In order to generate purified water, processes such as precipitation, filtration, and sterilization may be performed, and harmful substances are generally removed through these processes, or the like.

In general, various filters may be provided in a water dispensing device to purify raw water. These filters may be classified into a sediment filter, an activated carbon filter, an ultrafiltration (UF) hollow fiber membrane filter, a reverse osmosis (RO) membrane filter, and the like, according to their functions. The sediment filter may refer to as a filter for precipitating contaminants or suspended matter having large particles in raw water, and the activated carbon filter may refer to as a filter for adsorbing and removing contaminants with small particles, residual chlorine, volatile organic compounds, or odor generation factors.

In addition, two activated carbon filters may generally be provided. In other words, two activated carbon filters may include a pre-activated carbon filter provided on the raw water side and a post-activated carbon filter provided on the purified water side. The post activated carbon filter may be provided to improve the taste of water by removing odor-causing substances that mainly affect the taste of purified water. In addition, the UF hollow fiber membrane filter and the RO membrane filter are generally used selectively.

Recently, the demand for a water purifier or a refrigerator having a water purifying function has increased significantly. Therefore, there is a problem that various requirements are generated and it is difficult to satisfy the various requirements at the same time.

As an example, it is possible to remove heavy metals by applying the RO membrane filter, but there is a problem in that it is difficult to secure the purified water flow rate. In other words, there is a problem in that it takes a lot of time to obtain a desired amount of purified water. On the other hand, in the case of the UF hollow fiber membrane filter, it is possible to secure a high flow rate, but since it is difficult to remove heavy metals in water, there is a problem in that it is difficult to use groundwater or tap water from a contaminated area as raw water.

Therefore, removal of heavy metals and securing high flow rates were inevitably recognized as contradictory problems. This is because, when using an RO membrane filter to remove heavy metals, it is difficult to secure high flow rate, and when using a UF hollow fiber membrane filter to secure high flow rate, it becomes difficult to remove heavy metals.

In addition, in the conventional case, when a carbon block is used as a single filter, it is difficult to remove viruses and bacteria, and when several filters are individually provided, there was a problem in that the volume of the filter increases. In addition, since the UF filter (ultrafiltration filter) or the electrostatic adsorption filter is a chemical product, when the UF filter or the electrostatic adsorption filter is applied last, an issue occurs in that the taste of water changes.

In addition, virus removal performance may be affected by the quality of the raw water. In the case of overseas areas, the quality of raw water is often worse than that of domestic water. Therefore, if the filter does not properly remove the virus in the water, there is also a problem that the filter performance is reduced.

### BRIEF DESCRIPTION OF THE DRAWINGS

Embodiments will be described in detail with reference to the following drawings in which like reference numerals refer to like elements, and wherein:

FIG. 1 is a water pipe diagram illustrating a water dispensing device to which a filter module according to the present disclosure is applied;

FIG. 2 is a perspective view illustrating a filter module for a water dispensing device according to an embodiment of the present disclosure;

FIG. 3 is a cross-sectional view illustrating a filter module for a water dispensing device according to an embodiment of the present disclosure;

FIG. 4 is a view in which the flow direction of water is indicated by arrows in FIG. 3;

FIG. 5 is a perspective view illustrating a state where an electrostatic adsorption nonwoven fabric and a second carbon block, which are some components of the present disclosure, are coupled; and

FIG. 6 is a table illustrating the components to be removed by each material constituting the present disclosure.

### DETAILED DESCRIPTION

Hereinafter, specific embodiments of the present disclosure will be described in detail with reference to the drawings. However, the idea of the present disclosure is not limited to the embodiments presented below, and those skilled in the art who understand the idea of the present disclosure will be able to easily implement other embodiments included within the scope of the same idea by adding, changing, deleting, and adding components, but this will also be said to be included within the scope of the present disclosure.

The drawings accompanying the following embodiments are embodiments of the same inventive idea, but within the scope that the inventive idea is not damaged, in order to be easily understood, the expression of minute parts may be expressed differently for each drawing, and, according to the drawing, a specific part may not be displayed or may be exaggerated according to the drawing.

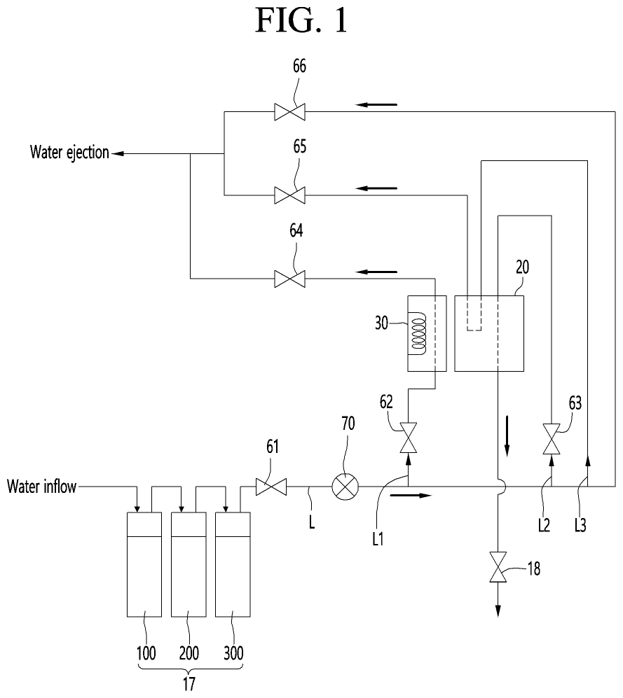

FIG. 1 is a water pipe diagram illustrating a water dispensing device to which a filter module according to the present disclosure is applied. The water dispensing device according to the present disclosure is for directly taking out purified water after purifying water supplied from an external water supply source, cooling the water or heating the water to take the water out, and may refer to, for example, a direct water type purifier. Here, the direct water type purifier refers to a type of water purifier in which water passes through a filter in real time and purified water is ejected when a user requests for ejection of purified water without a storage tank in which purified water is stored.

In addition, the water dispensing device according to the present disclosure may refer to a refrigerator having a water purification function. In other words, while being a refrigerator, the water dispensing device may refer to a water purifier refrigerator including a filter for purifying raw water and a water ejection nozzle through which purified water is ejected. In addition, the water dispensing device according to the present disclosure may refer to an under sink type water purifier in which the main body is installed under the sink and the water ejection nozzle is installed outside the sink. In addition, the water dispensing device according to the present disclosure may refer to various types of known devices that receive water from a water supply source, pass the water through a filter to perform water purification treatment, and then supply the purified water to the outside.

Referring to FIG. 1, in the water dispensing device according to an embodiment of the present disclosure, a water supply line L is formed from a water supply source to a water ejection port, and various valves and parts can be connected to the water supply line L. More specifically, the water supply line L is connected to the water supply source, for example, a domestic faucet, or the like, and a filter module 17 is disposed at a certain point of the water supply line L and thus foreign substances contained in drinking water which is supplied from the water supply source are filtered.

In addition, the water supply valve 61 and the flow rate sensor 70 may be sequentially disposed in the water supply line L connected to the discharge port end of the filter module 17. Accordingly, when the supply amount sensed by the flow rate sensor 70 reaches a set flow rate, the water supply valve 61 may be controlled to be closed. In addition, at any point of the water supply line L extending from the discharge port end of the flow sensor 70, a water supply line for hot water supply L1, a water supply line for cold water supply L3, and a water supply line for cooling water supply L2 may be branched.

In addition, a purified water ejection valve 66 may be mounted at the end portion of the water supply line L extending from the discharge port end of the flow sensor 70, and a hot water ejection valve 64 may be mounted at the end portion of the water supply line for hot water supply L1. In addition, a cold water ejection valve 65 may be mounted at an end portion of the water supply line for cold water supply L3, and a cooling water valve 63 may be mounted at any point of the water supply line for cooling water supply L2. The cooling water valve 63 may adjust the amount of cooling water supplied to the cooling water generation part 20.

In addition, the water supply line extending from the discharge port ends of the hot water ejection valve 64, the cold water ejection valve 65, and the purified water ejection valve 66 are all connected to the water ejection port. In addition, as illustrated, the purified water, cold water, and hot water may be configured to be connected to a single take-out port or may be configured to be respectively connected to independent take-out ports in some cases.

Hereinafter, a supply process of water purification will be described with reference to FIG. 1. In the case of purified water, when the purified water ejection valve 66 is opened by pressing the purified water selection button on the manipulation display part, purified water that has passed through the filter module 17 may be taken out through the water ejection port.

Hereinafter, a cold water and hot water supply process will be described with reference to FIG. 1. First, in the case of cold water, when the cooling water valve 63 is opened and cooling water is supplied to the cold water generation part 20, while the water in the water supply line for cold water supply L3 passing through the cold water generation part 20 is cooled by the cooling water, cold water is produced. In this case, the water supply line for cooling water supply L2 may include a refrigerant cycle for cooling the cooling water. The refrigerant cycle may include a compressor, a condenser, an expansion valve, an evaporator, and the like. Thereafter, when the cold water ejection valve 65 is opened by pressing the cold water selection button of the manipulation display part, cold water may be taken out through the water ejection port.

Meanwhile, in the case of hot water, hot water is generated while the water flowing along the water supply line for hot water supply L1 is heated by the hot water heater 30, and when the hot water ejection valve 64 is opened by pressing the hot water selection button of the manipulation display part, hot water may be taken out through the water ejection port.

The filter module 17 of the water dispensing device according to an embodiment of the present disclosure having the above configuration includes at least one filter to generate purified water from raw water. Hereinafter, a filter module for a water dispensing device according to an embodiment of the present disclosure will be described.

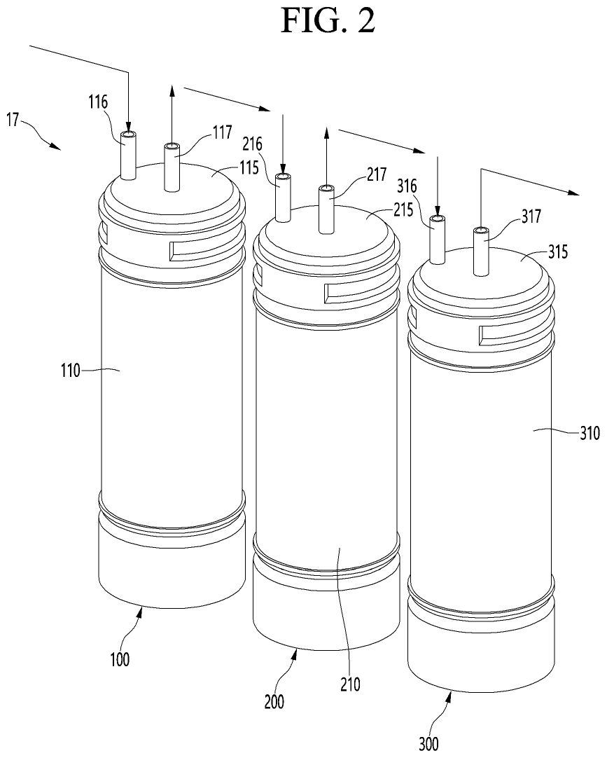

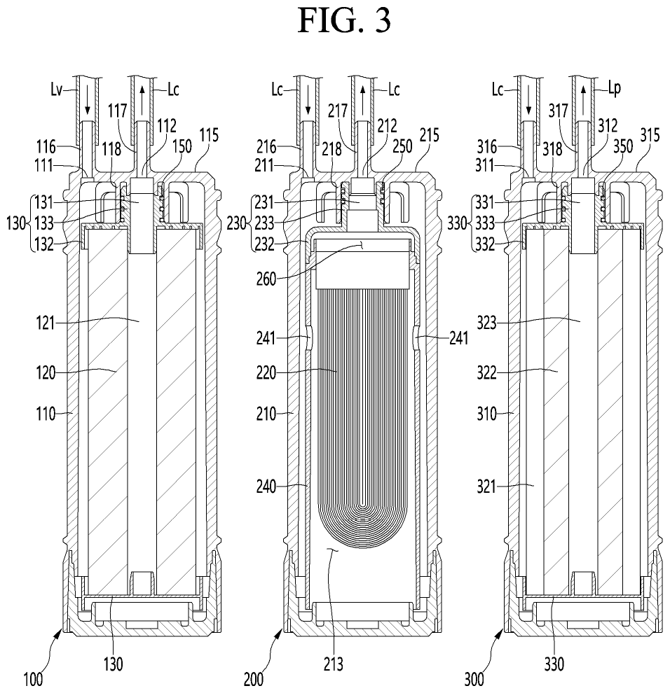

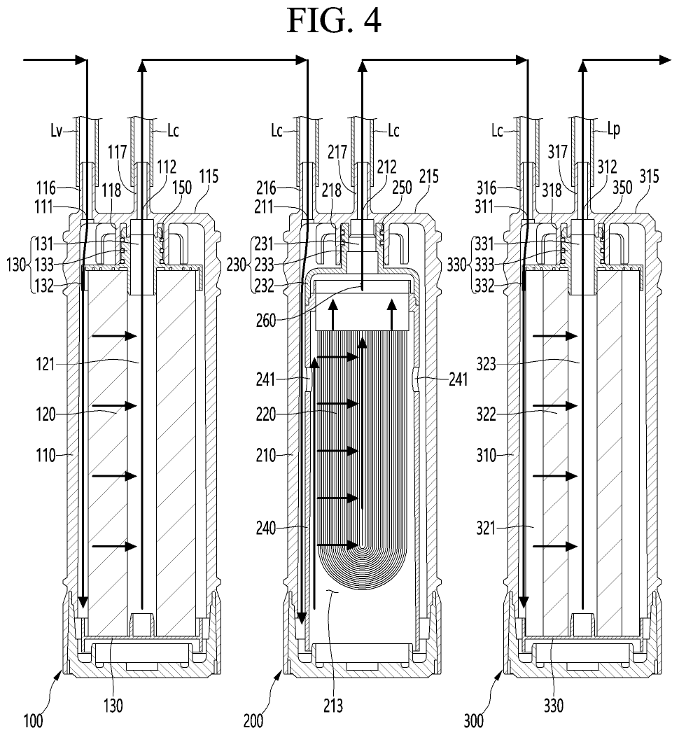

FIG. 2 is a perspective view illustrating a filter module for a water dispensing device according to an embodiment of the present disclosure, FIG. 3 is a cross-sectional view illustrating a filter module for a water dispensing device according to an embodiment of the present disclosure, and FIG. 4 is a view in which the flow direction of water is indicated by arrows in FIG. 3. Referring to FIGS. 2 to 4, the filter module for a water dispensing device according to an embodiment of the present disclosure includes a plurality of filters.

The filter module 17 for the water dispensing device may be detachably coupled to a filter socket (not illustrated) installed on the water supply flow path L. For example, the filter socket may form three filter connection parts so that a total of three filters 100, 200, and 300 are mounted.

The filter module 17 may have one side (the left side of FIG. 3) connected to the raw water flow path Lr in which raw water flows, and the other side (the right side of FIG. 3) connected with the purified water flow path Lp through which the purified water is discharged. The raw water flow path Lr may be connected to a water supply source, and the water supply line for hot water supply L1 and the water supply line for cold water supply L3 may branch from the purified water flow path Lp.

Referring to FIGS. 2 to 4, the filter module 17 for the water dispensing device may include a pre-filter 100. In addition, the filter module 17 for the water dispensing device may include a hollow fiber membrane filter 200. In addition, the filter module 17 for the water dispensing device includes a composite filter 300.

In addition, the filter module 17 for the water dispensing device may include a plurality of filters selected from the pre-filter 100, the hollow fiber membrane filter 200, and the composite filter 300. For example, the filter module 17 for the water dispensing device may include all of the pre-filter 100, the hollow fiber membrane filter 200, and the composite filter 300. In addition, the pre-filter 100, the hollow fiber membrane filter 200, and the composite filter 300 may be sequentially disposed along the flow direction of water.

Each of the filters 100, 200, and 300 may include a filter housing 110, 210, 310 having an inflow port and a discharge port, and a filtration member provided in the filter housing 110, 210, 310 to purify the water flowing therein through the inflow port. Discharge ports 112, 212, 312 through which water is discharged are formed in the upper center of the filter housings 110, 210, and 310, and inflow ports 111, 211, 311 in which water flows are formed on the outside of the discharge ports 112, 212, and 312.

The water flowing into the filter housings 110, 210, and 310 through the inflow ports 111, 211, and 311 is purified while passing through the filtration member, and then, through the discharge ports 112, 212, 312, can be discharged out of the filter housings 110, 210, 310. In addition, the water flowing into the inflow ports 111, 211, 311 flows from the upper side to the lower side along the inflow path defined by the inner surface of the filter housing 110, 210, 310 and then passes through the filtration member, and the water passing through the filtration member flows from the lower side to the upper side along the discharge flow path located on the central side of the inflow path, and then exits to the outside of the filter housings 110, 210, 310 through the discharge ports 112, 212, and 312.

The pre-filter 100 has an inflow port 111 and a discharge port 112 formed therein and may include a first filter housing 110 having a space 113 therein and a filtration member accommodated in the first filter housing 110. The filtration member of the pre-filter 100 may be provided as a first carbon block 120 having a hollow shape. Accordingly, the raw water flowing into the filter module 17 may be filtered firstly while passing through the first carbon block 120.

Referring to FIG. 4, the raw water flowing into the pre-filter 100 through the inflow port 111 flows therein from the upper side to the lower side through a space between the first filter housing 110 and the outer surface of the first carbon block 120 and then is filtered while passing through the first carbon block 120. In addition, the water passing through the first carbon block 120 flows from the lower side to the upper side through the hollow 121 of the first carbon block 120 and, through the discharge port 112 communicating with the hollow 121, is discharged to the outside of the pre-filter 100.

Then, the water flowing out of the pre-filter 100 flows to the hollow fiber membrane filter 200. The filtration member of the hollow fiber membrane filter 200 may be provided with a plurality of hollow fiber membranes 220 (UF Membrane). Accordingly, the water flowing into the hollow fiber membrane filter 200 may be filtered secondly while passing through the hollow fiber membrane 220.

Referring to FIG. 4, a hollow inner cover 240 is disposed in the space 213 inside the second filter housing 210, and a hollow fiber membrane 220 is disposed inside the inner cover 240. Then, the water flowing into the hollow fiber membrane filter 200 through the inflow port 211 flows from the upper side to the lower side along the flow path defined by a space between the second filter housing 210 and the hollow inner cover 240.

Thereafter, the water flows into the inner side of the inner cover 240 through a space between the lower end of the inner cover 240 and the second filter housing (210). A hollow fiber membrane 220 is disposed on the inner side of the inner cover 240, and the water flowing into the inner cover 240 is filtered secondly while passing through the hollow fiber membrane 220 and then is discharged to the outside of the second filter housing 210 through the discharge port 212.

In addition, in the inner cover 240, an intermediate hole 241 communicating the outer space and the inner space of the inner cover 240 is formed, and the water flowing into the second filter housing 210 may flow from the upper side to the lower side along the inner surface of the second filter housing 210 and the outer surface of the inner cover 240 and may flow into the inner space of the inner cover 240 through the intermediate hole 241.

Then, the water flowing into the inner cover 240 is secondly filtered while passing through the hollow fiber membrane 220, and then discharged to the outside of the second filter housing 210 through the discharge port 212. Then, the water that exits through the hollow fiber membrane filter 200 flows to the composite filter 300.

Composite filter 300 may include an electrostatic adsorption member through which water passing through the hollow fiber membrane filter 200 thirdly passes, and a second carbon block 322 through which water passing through the electrostatic adsorption member passes fourthly. The electrostatic adsorption member may mean, for example, the electrostatic adsorption nonwoven fabric (or electrostatic adsorption filter) 321. In the following description, the electrostatic adsorption member will be described as the electrostatic adsorption nonwoven fabric 321, but the scope of the present disclosure is not limited thereto, and the electrostatic adsorption member may be made of various materials having an electrostatic adsorption function in addition to the electrostatic adsorption nonwoven fabric 321.

Meanwhile, in the above case, the filtration member of the composite filter 300 may include an electrostatic adsorption nonwoven fabric 321 and a second carbon block 322. Therefore, the water flowing into the composite filter 300 is thirdly filtered while passing through the electrostatic adsorption non-woven fabric 321, is fourthly filtered while passing through the second carbon block 322, and finally may be discharged to the outside of the composite filter 300.

Referring to FIG. 4, an electrostatic adsorption nonwoven fabric 321 and a second carbon block 322 are disposed in the inner space of the third filter housing 310. Then, the water flowing into the composite filter 300 through the inflow port 311 flows from the upper side to the lower side along the inner surface of the third filter housing 310, is filtered while passing through the electrostatic adsorption nonwoven fabric 321 and the second carbon block 322, and flows from the lower side to the upper side through the hollow 323 of the second carbon block 322. Thereafter, the water exits the third filter housing 310 through the discharge port 312 communicating with the hollow 323 of the second carbon block 322.

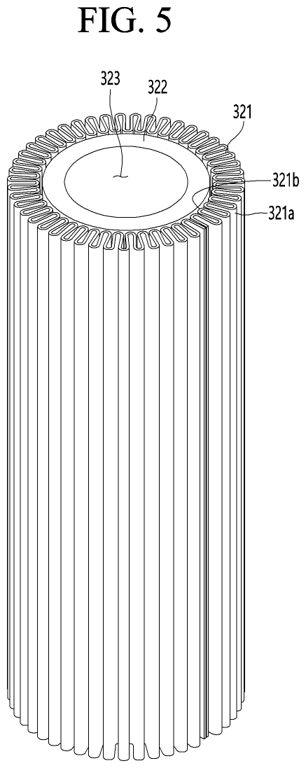

FIG. 5 is a perspective view illustrating a state where an electrostatic adsorption nonwoven fabric and a second carbon block, which are some components of the present disclosure, are coupled. Referring to FIGS. 3 to 5, the electrostatic adsorption nonwoven fabric 321 may form a hollow part.

The electrostatic adsorption nonwoven fabric 321 may have a hollow pipe shape as a whole. In addition, the electrostatic adsorption nonwoven fabric 321 may include powdered activated carbon particles.

In addition, the electrostatic adsorption nonwoven fabric 321 may form a closed curve by crimping a rectangular nonwoven fabric and thermally fuse in a state where both end portions of the nonwoven fabric are in contact. The electrostatic adsorption nonwoven fabric 321 includes a plurality of convex parts (or convex surfaces) 321a formed to be convex outward and concave part (concave surfaces) 321b provided between the convex parts 321a, so that wrinkles can be formed along the circumferential direction. In the present disclosure, a case where wrinkles are formed in the electrostatic adsorption nonwoven fabric 321 will be described as an example, but the scope of the present disclosure is not limited thereto, and the electrostatic adsorption nonwoven fabric 321 may be smoothly formed without wrinkles.

In addition, the electrostatic adsorption nonwoven fabric 321 may be formed in a rolling type like a rolled toilet paper. In addition, the electrostatic adsorption nonwoven fabric 321 may be formed as a single layer. In addition, the electrostatic adsorption nonwoven fabric 321 may be formed in multiple layers.

Meanwhile, as described above, when the electrostatic adsorption nonwoven fabric 321 is formed to be wrinkled, the surface area of the electrostatic adsorption nonwoven fabric 321 increases, and heavy metals in water can be more reliably removed. In addition, when the electrostatic adsorption nonwoven fabric 321 is formed in multiple layers, heavy metals in water can be more reliably removed.

The electrostatic adsorption nonwoven fabric 321 may be disposed to surround the outer surface of the second carbon block 322. In this embodiment, the electrostatic adsorption nonwoven fabric 321 and the second carbon block 322 may be accommodated in one filter housing 310 to constitute the composite filter 300. Then, while flowing from the lower side to the upper side, the water flowing into the filter housing 310 passes through the electrostatic adsorption nonwoven fabric 321 and the second carbon block 322 in order.

As described above, when the water flowing into the filter housing 310 passes through the electrostatic adsorption nonwoven fabric 321, the virus in the water may be removed. In addition, when the water flowing into the filter housing 310 passes through the electrostatic adsorption nonwoven fabric 321, heavy metals such as chromium (Cr) and selenium (Se) in the water may be removed.

For example, in the present disclosure, the electrostatic adsorption nonwoven fabric 321 may be implemented by applying a polyamine-based polymer positively charged functional group to a cellulose support body. For reference, the virus is negatively charged in tap water state (neutral pH), and when passing through a filter including the electrostatic adsorption nonwoven fabric 321, the virus is removed while being electrostatically adsorbed by a positively charged functional group. Accordingly, when the water flowing into the filter housing 310 passes through the electrostatic adsorption nonwoven fabric 321, the virus and fine particles in the water may be adsorbed and removed through positive charge adsorption.

The electrostatic adsorption nonwoven fabric 321 may also be referred to as a ‘positive charge adsorption nonwoven fabric’ from a functional point of view. Here, the electrostatic adsorption nonwoven fabric 321 is a material different from the ‘anion nonwoven fabric’.

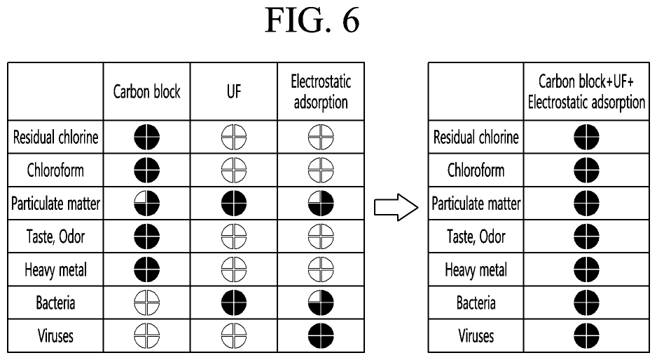

FIG. 6 is a table illustrating the components to be removed by each material constituting the present disclosure. Referring to FIG. 6, when water passes through a plurality of carbon blocks, it can be confirmed that residual chlorine, chloroform, particulate matter, and heavy metals in the water are removed, and taste, odor, and the like are reduced.

In addition, when water passes through the hollow fiber membrane, it can be confirmed that particulate matter and bacteria in the water are removed. In addition, when water passes through the electrostatic adsorption nonwoven fabric, it can be confirmed that particulate matter, bacteria, and viruses are removed.

Therefore, as in the present disclosure, when the water flowing into the filter module 17 passes through the plurality of carbon blocks 120 and 322, the hollow fiber membrane 220, and the electrostatic adsorption nonwoven fabric 321, residual chlorine, chloroform, particulate matter, heavy metals, bacteria, and viruses in water can be removed.

In addition, since the water flowing into the composite filter 300 finally passes through the second carbon block 322, the smell of water is removed and the taste of water is improved. Meanwhile, as described above, when the electrostatic adsorption nonwoven fabric 321 and the second carbon block 322 are disposed in one filter housing 310, the filtration efficiency can increase and the purified water flow rate can be maintained.

In addition, there is no need to expand the filter installation space formed in the water purifier, refrigerator, or the like and it can be applied immediately by simply replacing the existing filter. In addition, space utilization can increase by reducing the volume of the filter, and furthermore, slimming of a water purifier, a refrigerator, and the like can be realized.

At least one of the carbon blocks 120 and 322 may be formed by processing a mixture containing activated carbon and a binder. The activated carbon may be included in the form of granular or powder. As described above, when the carbon blocks 120 and 322 include activated carbon, the carbon blocks 120 and 322 can effectively remove heavy metals in water and also residual chlorine components in water. Accordingly, the taste of water may also be improved. In addition, chloroform (CHCL₃) in water can be also effectively removed by the activated carbon.

In addition, the carbon blocks 120 and 322 include a binder. The binder connects the activated carbon and the selectively mixed functional material to each other and is mixed to impart rigidity.

With the configuration of the binder, the activated carbon and the functional material may be processed in the form of a block having rigidity. For example, the functional material may include titanium oxide (for example, Na₄TiO₄) and Ferric Hydroxide. In other words, the carbon blocks 120 and 322 may be prepared by mixing activated carbon and a binder and may be prepared by further including titanium oxide (for example, Na₄TiO₄) and Ferric Hydroxide.

For reference, the carbon blocks 120 and 322 may be formed by uniformly mixing a plurality of materials, including activated carbon and a binder, and then putting it in a mold and heating it. A binder (for example, polyethylene, PE) is melted by heating in the mold, and materials such as activated carbon are coupled. Accordingly, the carbon blocks 120 and 322 in the form of blocks having overall rigidity can be formed.

Hereinafter, additional configurations of each filter will be described. The pre-filter 100 may further include a filter bracket 130 accommodated inside the filter housing 110 and coupled to the upper side and/or lower side of the first carbon block 120.

The filter housings 110, 210, and 310 may form upper surfaces 115, 215, and 315 of which at least a portion is flat. In addition, discharge ports 112, 212, and 312 may be formed at the center of the upper surfaces 115, 215, and 315. In addition, inflow ports 111, 211, and 311 may be formed outside the discharge ports 112, 212 and 312 of the upper surfaces 115, 215, and 315.

In addition, on the upper surfaces 115, 215, 315 of the filter housings 110, 210, 310, hollow discharge pipes 117, 217, 317 extending upward from the discharge ports 112, 212, 312, and hollow inflow pipes 116, 216, 316 extending upward from the inflow ports 111, 211, 311 can be formed. The inflow pipes 116, 216, 316 and the discharge pipes 117, 217 and 317 may be formed to protrude upward from the upper surfaces 115, 215 and 315 of the filter housings 110, 210 and 310.

Referring to FIGS. 3 to 4, the inflow pipe 116 and the discharge pipe 117 are formed on the upper surface 115 of the filter housing 110 of the pre-filter 100. In addition, the inflow pipe 116 is connected to the raw water flow path Lr connected to the water supply source. Accordingly, the raw water flowing into the raw water flow path Lr flows into the filter housing 110 through the inflow pipe 116 and the inflow port 111, and passes through the first carbon block 120. While passing through the first carbon block 120, the water which firstly purified is discharged to the outside of the filter housing 110 through the discharge port 112 and the discharge pipe 117.

For example, the end portion of the inflow pipe 116 may be inserted into and connected to the end portion of the raw water flow path Lr and may be connected through a separate connecting member. In addition, the discharge pipe 117 of the pre-filter 100 is connected to the inflow pipe 216 of the hollow fiber membrane filter 200.

The discharge pipe 117 of the pre-filter 100 and the inflow pipe 216 of the hollow fiber membrane filter 200 may be connected through a separate connection pipe Lc. The end portion of the discharge pipe 117 of the pre-filter 100 and the inflow pipe 216 of the hollow fiber membrane filter 200 may be connected by being inserted into the end portion of the connecting pipe Lc and may be connected through a separate connecting member.

The connecting pipe Lc may be provided as a hose having elasticity. Accordingly, the water flowing into the connection pipe Lc, which is firstly purified, flows into the filter housing 210 through the inflow pipe 216 and the inflow port 211 and passes through the hollow fiber membrane 220. The water which is secondly purified while passing through the hollow fiber membrane 220 is discharged to the outside of the filter housing 210 through the discharge port 212 and the discharge pipe 217.

In addition, the discharge pipe 217 of the hollow fiber membrane filter 200 is connected to the inflow pipe 316 of the composite filter 300. The discharge pipe 217 of the hollow fiber membrane filter 200 and the inflow pipe 316 of the composite filter 300 may also be connected through a separate connection pipe Lc. The end portions of the discharge pipe 217 of the hollow fiber membrane filter 200 and the inflow pipe 316 of the composite filter 300 may be connected by being inserted into the end of the connecting pipe Lc and may be connected through a separate connecting member.

Accordingly, the water flowing into the connecting pipe Lc, which is secondly purified flows into the filter housing 310 through the inflow pipe 316 and the inflow port 311 and passes through the electrostatic adsorption nonwoven fabric 321 and the second carbon block 322. The water which is thirdly purified while passing through the electrostatic adsorption nonwoven fabric 321 and is fourthly purified while passing through the second carbon block 322 is discharged to the outside of the filter housing 310 through the discharge port 312 and the discharge pipe 317.

In addition, the water discharged to the outside of the filter housing 310 may be connected to the purified water flow path Lp. For example, the end portion of the discharge pipe 317 may be inserted into and connected to the end portion of the purified water flow path Lp and may be connected through a separate connecting member.

Again, referring to FIGS. 3 to 4, filter brackets 130, 230, and 330 are coupled to the upper end of the filtration member, and hollow parts 131, 231, 331 communicating with the discharge ports 112, 212, and 312 may be formed in the filter brackets 130, 230, 330. The hollow part 131 of the filter bracket 130 may also communicate with the hollow 121 of the first carbon block 120. Accordingly, water in the hollow 121 of the first carbon block 120 may flow to the discharge port 112 and the discharge pipe 117 through the hollow part 131 of the filter bracket 130.

In addition, the hollow part 231 of the filter bracket 230 may communicate with the chamber 260 formed at the outlet end of the hollow fiber membrane 220. The filter bracket 230 may be connected to the upper side of the inner cover 240, and the chamber 260 may be defined by the lower end of the filter bracket 230 and the upper end of the inner cover 240. Accordingly, water flowing into the chamber 260 after passing through the hollow fiber membrane 220 may flow to the discharge port 212 and the discharge pipe 217 through the hollow part 231 of the filter bracket 230.

Also, the hollow part 331 of the filter bracket 330 may communicate with the hollow 323 of the second carbon block 322. Accordingly, water in the hollow 323 of the second carbon block 322 may flow to the discharge port 312 and the discharge pipe 317 through the hollow part 331 of the filter bracket 330.

In addition, the filter brackets 130, 230, and 330 may include cover parts (or covers) 132, 232, 332 for covering the upper surface of the filtration member, and extension parts (or extensions) 133, 233, 333 extending upward from the center of the upper end of the cover part 132, 232, 332. In addition, the filter housings 110, 210, and 310 are formed with hollow insertion parts (or insertion openings) 118, 218, and 318 extending downward from the inner upper end, and the extension parts 133, 233, 333 may be inserted into the insertion parts 118, 218, and 318. Further, sealing members 150, 250, and 350 may be inserted between the extension parts 133, 233, 333 and the insertion parts 118, 218, 318.

Hereinafter, the manufacturing process of the carbon blocks 120 and 322, which are some components of the present disclosure, will be briefly described. First, each material constituting the carbon blocks 120 and 322 is mixed in a proportion to create a carbon block mixture.

Then, the evenly mixed carbon block mixture is filled in the mold. Then, the evenly mixed carbon block mixture goes through a compression process and is put into an electric furnace. Then, a heating process is performed. In the heating process, the binder, for example, polyethylene (PE) is melted, the activated carbon and the binder are integrally coupled, and the carbon blocks 120 and 322 in the form of a hollow tube having overall rigidity may be molded.

In addition, after heating, cooling proceeds, and when cooling is completed, the mold is separated. In addition, the hollow tube-shaped carbon block separated from the mold may be cut to a unit length. In addition, the cut carbon blocks 120 and 322 may be cleaned by spraying compressed air. After that, the dimensions and the weight are checked, and if there are no abnormalities, packaging is performed.

According to the present disclosure as described above, there is an aspect that the water flowing into the filter housing passes through the electrostatic adsorption filter and then flows out to the outside of the filter housing, so that viruses, bacteria, particulate matter, or the like can be reliably removed, and the filtration power can be improved.

According to the present disclosure, there is an aspect that a flow path can be secured so that water flowing into the filter housing passes through the electrostatic adsorption filter and the carbon block in turn, and then exits to the outside of the filter housing. According to the present disclosure, there is also an aspect that the specific surface area of the electrostatic adsorption nonwoven fabric increases, and thus the filter life can be prolonged.

According to the present disclosure, there is an aspect of more reliably removing particulate matter, bacteria, and viruses contained in water. According to the present disclosure, there is an aspect of preventing the taste of water finally supplied to the user from being changed.

According to the present disclosure, there is an aspect that the water purification process is performed several times by a plurality of filters, and thus the removal of various foreign substances including heavy metals can be performed more reliably. According to the present disclosure, since only the material of the filter is changed and the shape or disposition structure of a filter applied to a water purifier, a refrigerator, or the like is not changed, there is an aspect that the present disclosure can be directly applied to an existing refrigerator, a water purifier, or the like.

According to the present disclosure, there is an aspect that space utilization can be increased by deposing heterogeneous filters in one filter housing in the transverse direction to reduce the volume of the filter, and furthermore, the slimming of refrigerators and water purifiers can be realized.

The present disclosure provides a filter module for a water dispensing device which can more reliably remove viruses, bacteria, particulate matter, or the like by allowing the water flowing into the filter housing to pass through the electrostatic adsorption filter and then to exit to the outside of the filter housing. The present disclosure provides a filter module for a water dispensing device that secures a flow path so that water flowing into a filter housing passes through an electrostatic adsorption filter and a carbon block in turn, and then exits to the outside of the filter housing.

The present disclosure provides a filter module for a water dispensing device capable of more reliably removing particulate matter, bacteria, and viruses contained in water. The present disclosure proposes a filter module for a water dispensing device that prevents the taste of water finally supplied to a user from being changed.

The present disclosure provides a filter module for a water dispensing device that can be directly applied to an existing water purifier, refrigerator, or the like without changing the shape or disposition structure of the filter applied to the water purifier, refrigerator, or the like. The present disclosure provides a filter module for a water dispensing device that can increase space utilization by disposing heterogeneous filters in one filter housing in the transverse direction to reduce the volume of the filter.

A filter module for a water dispensing device according to the present disclosure includes a filter housing which has an inflow port and a discharge port, and a filtration member provided in the filter housing to purify water flowing therein through the inflow port and to supply purified water to the discharge port. In addition, the filter module may include a pre-filter through which raw water passes firstly and in which a first carbon block having a hollow shape is built-in, and a hollow fiber membrane (UF membrane) filter through which water passes through the pre-filter passes secondly.

In addition, the filter module may include an electrostatic adsorption nonwoven fabric through which water passing through the hollow fiber membrane filter passes thirdly, and a second carbon block through which water passing through the electrostatic adsorption nonwoven fabric passes fourthly. In addition, the electrostatic adsorption nonwoven fabric may have a hollow shape and may be disposed to surround an outer surface of the second carbon block.

In addition, the second carbon block and the electrostatic adsorption nonwoven fabric may be disposed inside a third filter housing to constitute a composite filter. In addition, the electrostatic adsorption nonwoven fabric may include a plurality of convex parts convex outwardly and a concave part provided between the convex parts and may be wrinkled along a circumferential direction thereof.

The electrostatic adsorption nonwoven fabric may be formed in multiple layers. The carbon block may be formed by processing a mixture containing activated carbon and a binder.

In addition, the water flowing into the filter housing may pass through the filtration member after flowing from the upper side to the lower side along the inner surface of the filter housing and exit to the outside of the filter housing while flowing from the lower side to the upper side. In addition, a hollow inner cover for accommodating the filtration member may be disposed in the filter housing.

In addition, the water flowing into the filter housing may flow from the upper side to the lower side along the inner surface of the filter housing and the outer surface of the inner cover and thus flow into the inner cover through a space between the lower end of the inner cover and the filter housing to pass through the filtration member. In addition, an intermediate hole communicating the outer space and the inner space of the inner cover may be formed in the inner cover, and the water flowing into the filter housing may flow from the upper side to the lower side along the inner surface of the filter housing and the outer surface of the inner cover and then flow into the inner space of the inner cover through the intermediate hole.

In addition, the filter housing may form an upper surface at least a part of which is made of a flat surface, the discharge port may be formed on the central side of the upper surface, and the inflow port may be formed outside the discharge port of the upper surface. In addition, a hollow discharge pipe extending upward from the discharge port, and a hollow inflow pipe extending upward from the inflow port may be formed on the upper surface of the filter housing.

In addition, a filter bracket may be coupled to the upper end of the filtration member, and the filter bracket may have a hollow part communicating with the discharge port. In addition, the filter bracket may include a cover part covering the upper surface of the filtration member, and an extension part extending upwardly from the center of the upper end of the cover part. In addition, the filter housing may be formed with a hollow insert part extending downward from the upper end of the inner side, the extension part may be inserted into the insertion part, and a sealing member may be inserted between the extension part and the insertion part.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A filter module for a liquid dispensing device, the filter module comprising:
a filter housing which has an inflow port and a discharge port; and
a plurality of filters provided in the filter housing to purify water flowing therein through the inflow port and to supply purified water toward the discharge port, the plurality of filters including:
a pre-filter that receives water from the inflow port and that includes a first carbon block having a hollow shape;
a hollow fiber membrane filter that receives water from the pre-filter;
an electrostatic adsorption filter that receives water from the hollow fiber membrane filter; and
a second carbon block that receives water from the electrostatic adsorption filter.

2. The filter module of claim 1,
wherein the electrostatic adsorption filter has a hollow shape and is provided around an outer surface of the second carbon block.

3. The filter module of claim 2,
wherein the filter housing includes a first filter housing to receive the pre-filter, a second filter housing to receive the hollow fiber membrane filter, and a third filter housing, and
wherein the second carbon block and the electrostatic adsorption filter are provided inside the third filter housing to constitute a composite filter.

4. The filter module of claim 1,
wherein the electrostatic adsorption filter includes a plurality of convex surfaces that are convex outwardly and concave surfaces provided between the convex parts, and the electrostatic adsorption filter has a wrinkled shape along a circumferential direction thereof.

5. The filter module of claim 1,
wherein the electrostatic adsorption filter includes multiple layers.

6. The filter module of claim 1,
wherein at least one of the first carbon block or the second carbon block includes a mixture containing activated carbon and a binder.

7. The filter module of claim 1,
wherein water flowing in the filter housing passes through the filters after flowing downward along an inner surface of the filter housing and flows upward from the filters to exit the filter housing.

8. The filter module of claim 1, further comprising:
a hollow inner cover that receives at least one of the filters and is provided in the filter housing.

9. The filter module of claim 8,
wherein water flowing in the filter housing flows downward along an inner surface of the filter housing and an outer surface of the inner cover, and flows into the inner cover through a space between a lower end of the inner cover and a lower end of the filter housing to pass through at least one of the filters.

10. The filter module of claim 8,
wherein an intermediate hole is formed in the inner cover, and
wherein water flowing in the filter housing flows downward along an inner surface of the filter housing and an outer surface of the inner cover and then flows into an inner space of the inner cover through the intermediate hole.

11. The filter module of claim 1,
wherein the filter housing includes an upper surface, and at least a part of the upper surface is flat,
wherein the discharge port is provided on the upper surface, and
wherein the inflow port is provided separately from the discharge port.

12. The filter module of claim 11,
wherein a hollow discharge pipe extending upward from the discharge port, and a hollow inflow pipe extending upward from the inflow port are formed on the upper surface of the filter housing.

13. The filter module of claim 11,
wherein a filter bracket is coupled to an upper end of at least one of the filters, and
wherein the filter bracket includes a hollow opening communicating with the discharge port.

14. The filter module of claim 13,
wherein the filter bracket includes
a cover covering the upper surface of one or more of the filters, and
an extension extending upwardly from an upper end of the cover.

15. The filter module of claim 14,
wherein the filter housing includes an insertion opening extending downward from an upper end of an inner surface of the filter housing,
wherein the extension is inserted into the insertion opening, and
wherein a seal is provided between the extension and the insertion opening.

16. The filter module of claim 1, wherein the electrostatic adsorption filter includes an electrostatic adsorption nonwoven fabric.

17. A filter module for a liquid dispensing device, the filter module comprising:
a filter housing including an inflow port and a discharge port; and
a plurality of filters provided in the filter housing to purify water flowing therein, the plurality of filters including:
a pre-filter that receives water from the inflow port and that includes a first carbon block having a hollow shape;
a hollow fiber membrane filter that receives water from the pre-filter; and
a composite filter receives water from the hollow fiber membrane filter, the composite filter including an electrostatic adsorption filter and a second carbon block that receives water from the electrostatic adsorption filter, the discharge port receiving water that has passed through the composite filter.

18. The filter module of claim 17,
wherein the electrostatic adsorption filter has a hollow shape and is provided around an outer surface of the second carbon block.

19. The filter module of claim 17,
wherein the filter housing includes a first filter housing compartment to receive the pre-filter, a second filter housing compartment to receive the hollow fiber membrane filter, and a third filter housing compartment to receive the composite filter.

20. The filter module of claim 17, further comprising:
a hollow inner cover to receive at least one of the filters and provided in the filter housing.
